(19) United States
(12) Patent Application Publication
(10) Pub. No.: US 2007/0079113 A1
(43) Pub. Date: Apr. 5, 2007

(54) Automatic secure device introduction and configuration

(76) Inventors: Amol Kulkarni, Hillsboro, OR (US); Shriharsha Hegde, Beaverton, OR (US); Victor Lortz, Beaverton, OR (US)

Correspondence Address: INTEL CORPORATION;C/O INTELLEVATE, LLC, P.O. BOX 52050, MINNEAPOLIS, MN, 55402, US

(21) Appl. No.: 11/241,080

(22) Filed: Sep. 30, 2005

(51) Int. Cl. H04L 9/00

(52) U.S. Cl. 713/150

(57) ABSTRACT

Methods for transferring a credential between two devices according to a secure protocol are described. Portions of messages in the protocol are encrypted to prevent theft and tampering. Out-of-band (OOB) data is initially transferred to bootstrap trust in establishing one or more secure communication channels over which a new device may be configured. Systems using the methods are described and claimed.

### FIELD OF THE INVENTION

The invention relates to network device configuration. More specifically, the invention relates to secure methods of configuring devices to gain access to network resources.

### BACKGROUND

Wireless communication between computing devices has enjoyed wide adoption and significant growth as a flexible and cost-effective alternative to traditional hard-wired network infrastructure. Wireless technologies such as WiFi (a common name for several related standards proposed by the Institute of Electrical and Electronics Engineers, “IEEE”) and Bluetooth permit data transfer via radio signals in 2.4 GHz, 5 GHz, and other bands. New standards and improved equipment have increased data rates of wireless networks, but the technology has some issues that have not been satisfactorily addressed. Configurability and security of wireless networks are two of these.

Wireless networks rely on encryption of packets to prevent eavesdropping and unauthorized use of network resources. For example, the Wired Equivalent Privacy (“WEP”), which is a part of IEEE standard 802.11 describing wireless communications, specifies the encryption to be used in WiFi networks. Likewise, Wi-Fi Protected Access (WPA) is an alternative encryption and authentication standard based on mechanisms defined in the IEEE 802.11i standard. However, products supporting WEP, WPA, and similar security standards typically are difficult to configure correctly, so wireless networks are often run in unencrypted, “open” mode. Furthermore, even when encryption is enabled on a wireless local area network (“WLAN”), the participating systems often lack a standardized way to configure and change the security configuration. Easy-to-use, broadly-applicable procedures to configure and manage participants may be of considerable value.

### BRIEF DESCRIPTION OF DRAWINGS

Embodiments of the invention are illustrated by way of example and not by way of limitation in the figures of the accompanying drawings in which like references indicate similar elements.

FIG. 1 shows an exemplary network environment according to an embodiment of the invention.

FIG. 2 is a flow chart of an exemplary protocol transaction according to an embodiment of the invention.

FIG. 3 illustrates, according to one embodiment, a framework for establishing initial trust relationships between devices and communicating these trust relationships.

FIG. 4 illustrates a flowchart according to one embodiment for registering for and monitoring for device introduction notifications.

FIG. 5 illustrates an exemplary data-flow diagram for configuring a Shared Key based Virtual Private Network according to one embodiment.

FIG. 6 illustrates another exemplary data-flow diagram for configuring a certificate-based Virtual Private Network according to one embodiment.

FIG. 7 illustrates in accord with one embodiment a suitable environment in which certain aspects of the illustrated invention may be implemented.

### DETAILED DESCRIPTION

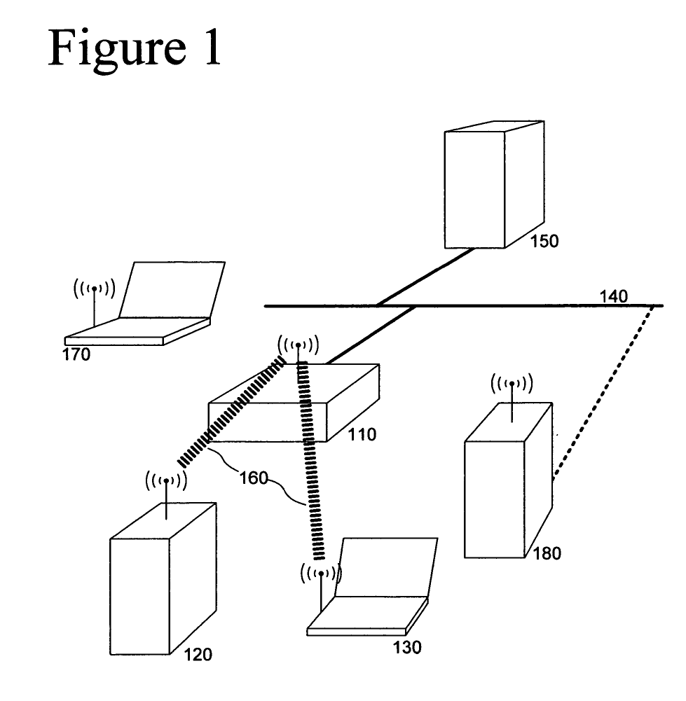

FIG. 1 shows entities that can make use of an embodiment of the invention to transfer credentials in a network such as a wireless local area network (“WLAN”) environment. Credentials may be passwords or encryption keys required to obtain access to network resources, or other configuration information that is useful or necessary to operate a WLAN device. Access point (“AP”) 110 is a central element in many WLANs: it communicates with one or more stations 120, 130 that use the wireless network, and may copy data packets to or from a traditional wired network 140 so that stations 120 and 130 can communicate with devices such as server 150 that lack a wireless interface. If WEP or WPA security is in effect, devices such as stations 120 and 130 must share an encryption key with AP 110. In this figure, WEP- or WPA-protected connections are indicated with thick dashed lines 160.

If the user of a device such as laptop WLAN client 170 wishes to use the wireless network through AP 110 to access resources on other wireless or wired nodes, he must obtain a valid encryption key and enter it into the wireless device's configuration. Traditionally, an administrator of the wireless network would provide the key and the user would type it into a configuration form. However, this approach is inconvenient for the user and cumbersome for the administrator. In addition, an unauthorized user may obtain a copy of the key from the user and use it to access the network. Changing the WLAN configuration to exclude such an unauthorized user may entail re-configuring all of the other authorized devices.

A superior method of managing access to the WLAN can be built on a registration protocol according to an embodiment of the invention. The protocol involves AP 110, new WLAN client 170 and a network entity called the Registrar, shown in this figure as device 180. In other embodiments, the Registrar may be integrated with the AP. Some networks may use several Registrars.

In some embodiments, as will be discussed in more detail below, device introduction into a new environment may utilize a relatively secure Out-Of-Band (OOB) channel to initially transfer data from an existing device, such as a Registrar or other device in the environment to a new device being introduced. This data may, for example, be used to at least temporarily establish a secure communication channel over which the new device may subsequently be configured. An Application Framework implementing the registration protocol may be used to provide a common framework for new device configuration. In one embodiment, application software for a device registers with the Application Framework, and the framework coordinates with the Registrar (or other existing device) and the new device to automatically configure the new device when it is introduced. Registrar 180 may communicate with AP 110 over the wired network 140, over a wireless (radio) connection, or both. The Registrar may provide administrative facilities to monitor the WLAN and manage WEP encryption keys.

In the illustrated embodiment, New WLAN client 170 has an associated secret called a device password which can be used as the OOB data to transfer for establishing the secure communication channel. The password may be engraved on the device or printed on a label, or may be displayed by the device or by software associated with the device. If the device password is displayed in this way, it may be dynamic (for example, the displayed password may be valid for a period of time or until some event occurs, then a new device password may be chosen and displayed). In some embodiments, the device password may be readable by a reader device near the new client. For example, Near Field Communication (“NFC”) devices can exchange data wirelessly over a short distance, so a device password might be stored in an NFC token and read by an NFC reader. In another embodiment, the new WLAN client might be equipped with an infrared or other light signal transmitter, and be able to transmit the device password to an optical receiver of the Registrar within line-of-sight proximity. These and other known techniques may be used to perform an OOB data transfer between the new device and the existing device in the environment, e.g., the Registrar, to facilitate establishing the secure communication channel.

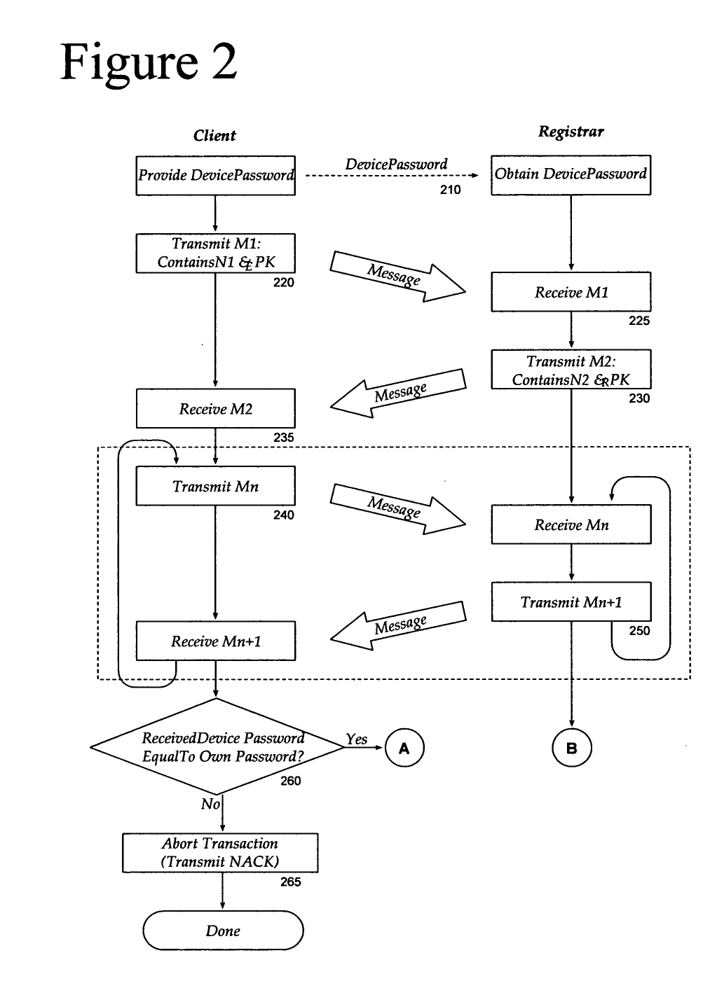

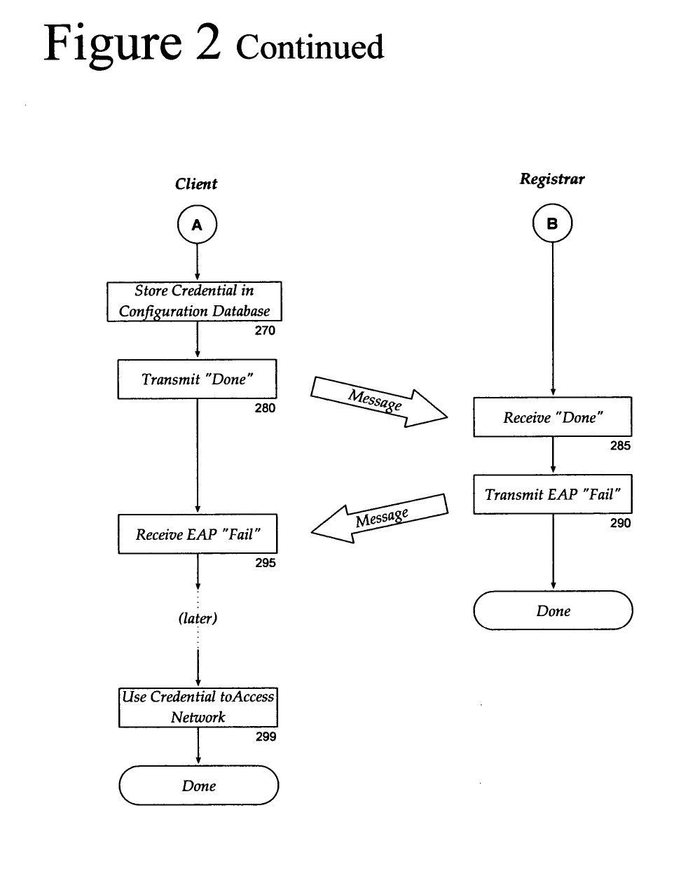

FIG. 2 illustrates a flow chart according to one embodiment to securely transfer a credential such as a WEP key from the Registrar to the client. Registrar 180, AP 110 and client 170 can interact according to FIG. 2. All messages can be sent in-band (for example, over the wireless communication channel), or some messages can be sent over a different channel. The embodiment described with reference to this figure uses the Extensible Authentication Protocol (“EAP”), as described in the Internet Engineering Task Force (“IETF”) Request for Comments (“RFC”) number 3748 dated June 2004, as a framework for transmitting and receiving many of the messages in the protocol. However, messages according to embodiments of the invention can be embedded within other communication frameworks or transmitted as raw data over any sort of communication channel.

First, the client's device password is provided to the Registrar 210. This may be accomplished by reading the password from the client's label or display and entering it through a Registrar user interface, by placing the client near the Registrar so that the Registrar can read the client's NFC token automatically, or via some other OOB method. Next, after initiating the EAP transaction 220 (not illustrated), the client transmits a first message (“M1”) (encapsulated within an EAP message) to initiate the introduction protocol with the Registrar. M1 contains a first random number N1 and a public key PK_{E} of the client, and may contain other information (described below). M1 is received by the Registrar 225.

The Registrar responds to M1 by transmitting a second message (“M2”) containing a second random number N2 and a public key PK_{R} of the Registrar 230. The client receives M2 235. The transaction continues with the client transmitting a message Mn 240 and the Registrar responding with message Mn+1 250. Portions of each message may be encrypted with a key known to both the client and the Registrar, or with a public or private key of one of the parties. Messages may have appended a message authentication code (“MAC”), containing a cryptographic hash of the previous message and a portion of the current message preceding the MAC, to permit the recipient to verify that the other party correctly received the previous message and that no third party is tampering with the messages in transit.

The key used to compute the HMAC in one or more of the messages from the Registrar is authenticated using a device password that should match the client's own device password. This permits the client to verify that it is receiving credentials from an authorized Registrar (and not, for example, from a rogue Registrar that is attempting to trick the client into connecting to a hostile wireless network). One or more of the messages from the Registrar contains a credential such as a WEP or WPA key that the client can use to access the wireless LAN through the AP. The credential may be encrypted with a key-encryption key to prevent its recovery by an eavesdropper. When the client receives the message containing the credential, it verifies the HMAC to ensure the message came from a Registrar with knowledge of its own device password 260. If the passwords differ, the client aborts the EAP transaction by transmitting a negative acknowledge (“NACK”) message 265. If the HMAC correctly verifies knowledge of the device password, the client may decrypt the credential and store it in a configuration database for future use 270.

Once the client has successfully received the credential, in an EAP context, the session is terminated. For example, this may be performed by transmitting a “Done” response to the Registrar 280, which receives the “Done” message 285 and responds with an EAP “Fail” message 290. The client subsequently receives the “Fail” message 295. Note that in this context, the failure message does not mean that the client must repeat the EAP transaction to obtain a credential. It merely indicates that the transaction was used to provision a credential rather than to grant the client immediate use of the wireless LAN. The client may use the credential it received later, when it attempts to access the network through the AP 299. For example, the client may update its configuration according to data in the credential, or may use the credential to complete a new authentication protocol transaction designed to provide network access.

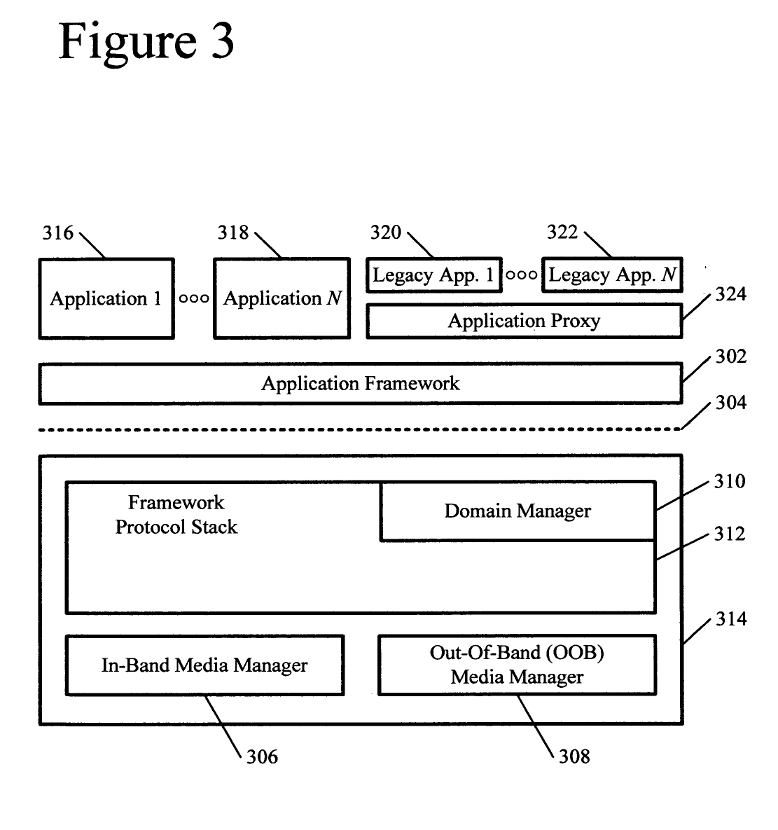

FIG. 3 illustrates, according to one embodiment, a framework 300 for establishing initial trust relationships between devices and communicating these trust relationships, e.g., between various operating system, device driver, and application software components.

In one embodiment, an Application Framework 402 is built on top of device introduction mechanisms, such as those described above with respect to FIGS. 1-2. In one embodiment, the Application Framework is initialized after sending the Done message and before responding with the Fail message and terminating the EAP session. It should be appreciated by one skilled in the art that the FIGS. 1, 2 EAP discussion is for exemplary purposes only and any message transport protocol may be used for credential setup (or boot-strapping). The illustrated Application Framework may be used by any application or device to bootstrap a secure communication channel. It will be appreciated that device discovery techniques, such as wireless or wired network discovery data probes, Universal Plug and Play (UPnP) operations, or other discovery techniques may be used to announce a new device's presence in an environment, locate Registrars or other devices of the environment, and manage networked devices.

In the illustrated embodiment, the components 306-312 below line 304 may be standardized or become well-defined by a Specification, such as described in the “Wi-Fi Simple Config Proposal”, the most current version at this time being Revision 0.95 dated Aug. 5, 2005.

The below the line 304 components 306-312 include an In-Band media manager 306 for managing a conventional communication connections such as a Bluetooth link, an Institute of Electrical and Electronics Engineers (IEEE) 802.x type of WLAN link, etc. It is presumed that this in-band communication channel is susceptible to attack. There is also an Out-Of-Band (OOB) media manager 308 for managing OOB communication channels, such as the various exemplary communication channels discussed above. The OOB communication channel is presumed difficult to attack, e.g., because it requires physical access to the communication medium/media, and hence is therefore deemed trustable for initial data exchanges to establish secure communication over the not-trusted in-band channel. It will be appreciated that the term “manager” in “media manager” is simply to refer to underlying hardware and/or software components, including operating system links, required to implement a particular communication channel.

The Domain Manager 310 generally provides information about existing domains to the Application Framework 302, and may also be used to generate and manage cryptographic keys as discussed above and in more detail below when establishing secure communication channels. As will be appreciated by one skilled in the art, a domain includes a set of one or more devices that recognize a common authority to grant and/or limit access to network or device resources.

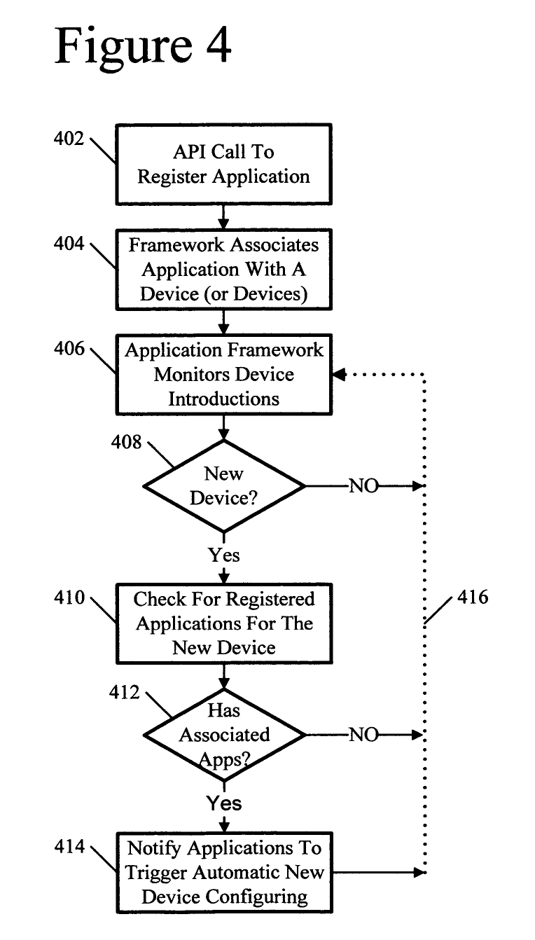

FIG. 4 illustrates a flowchart 400 according to one embodiment for registering for and monitoring for device introduction notifications and that may be considered in conjunction with the framework 300 of FIG. 3. An Application Programming Interface (API) is provided for the Framework Protocol Stack 312 to allow interacting with below line 304 components 306-312 from above the line. Software and/or hardware may make API calls to register 402 one or more applications, e.g., Application 1 316 to Application N 318 with the Application Framework 302. Note that while the present description focuses on application software registration, it should be appreciated that hardware devices may also be registered; however, for expository convenience, discussion will focus on software.

Once registered 404, e.g., an association is recorded between the application and a device (or devices), the Application Framework monitors 406 device introductions. If 408 so, as new devices are introduced into an environment, the Application Framework checks 410 to see if applications are registered for the new device. If 412 applications are registered, the registered applications associated with the new device are notified 414 when the introduction is complete so that they can engage in data exchanges to provide for automatic configuration of the new device. Note that in the illustrated embodiment processing loops 416 back to monitoring 406 for device introductions if 408 a new device is not seen, if it has no 412 associated apps, or after notifying 414 associated applications. The loop 416 is shown as a dotted line to suggest that processing might not literally loop directly back since a system implementing the illustrated embodiment may perform other tasks and/or processes not illustrated before returning to the monitoring 406.

By providing a way to automatically trigger applications on device introduction, this takes the burden off of an end user in having to know what software to run to configure the new device to work in an existing network, what order to attempt to utilize the software, etc. Note that multiple applications may be registered with a device and that priority and/or execution ordering data may be associated with the applications to capture dependencies that may exist between the applications, e.g., to allow designating that one application needs to be run before another. In the illustrated embodiment, integrating the API with the Framework Protocol Stack allows for standardizing the Framework Protocol Stack while also keeping it arbitrarily extensible through use of the API and other functions (not illustrated).

It will be appreciated that there may be many different API functions to implement the illustrated embodiments. The following table lists exemplary core API functions according to one embodiment to provide functionality such as registering applications, getting notifications, sending/receiving data, etc. as discussed herein:

| Function | Purpose |
|---|---|
| AfwRegister | Registers an application (or device) with the Application |
| | Framework (Afw), along with a Globally Unique ID (GUID) or |
| | equivalent to identify the application (or device) to the API |
| | (and/or other devices). |
| AfwDeregister | Deregisters the application (or device). |
| AfwNotifyCallback | Callback function to notify of events, such as introduction of a |
| | new device. |
| AfwGetKey | Retrieving an application specific key generated to allow for |
| | secure communication with a device. |
| AfwGetDomains | Retrieving domains known to the Application Framework. |
| AfwGetDevices | Retrieving devices for a given domain and application ID, e.g., |
| | identify devices in a given domain that have a particular |
| | registered application (or applications). |
| AfwGetApplications | Retrieving applications registered to a particular device, and if |
| | more than one domain is known, results can be limited to a |
| | specific domain. Applications need to know whether a peer |
| | application is available for bootstrapping trust. For example, a |
| | VPN Server application on one device needs to know there is a |
| | VPN client application on another device. Applications can |
| | query the Application Framework for list of devices in a domain |
| | having specific applications registered. Applications can also |
| | query for what applications are registered on a particular |
| | device in a particular domain. This is useful for a proxy that |
| | proxies multiple applications. |
| AfwSend | To send data to a peer application identified by its GUID via the |
| | Application Framework |
| AfwRecvCallback | Callback function to process data received from a peer |
| | application via the Application Framework |
| AfwGetDomainCACert | Retrieves a Certificate Authority (CA) certificate for a domain |
| | from the Application Framework, e.g., from the Registrar or |
| | other device operating as the CA. |
| AfwSignCSR | Signs a certificate request by an application with the |
| | Application Framework CA certificate. |
| AfwGetContextInfo | Retrieves domain and device information for a given |
| | application context, e.g., identified by its GUID. |

It will be appreciated that these functions may be available for use by a Registrar or other device and/or software of a particular environment, such as application software, e.g. FIG. 3 items 316, 318, an operating system, or the like. It will be further appreciated that other functions, not illustrated, may also be used. In one embodiment, an Expert System with appropriate rule sets may be used by the Application Framework 302 to analyze whether existing device configurations can and/or should be modified in light of a new device introduction, such as to take advantage of services now available from the new device. An expert system may also be used to control the execution order of associated applications, if needed, when multiple applications registrations exist for a device.

A device may be introduced in a variety of ways, such as, for example, by activating a wireless transceiver, pressing an “install” button or switch, plugging the device in to a bus communicatively coupled with the Application Framework, etc.. When the new device is recognized, e.g., FIG. 4 item 408, an installation “wizard” may become active on a Registrar and/or or on a user interface for the new device. In embodiments utilizing the above described API, the AfwNotifyCallback function would be called to trigger execution, e.g., FIG. 4 item 414 of the appropriate application(s), e.g. FIG. 3 items 316, 318, to handle the configuration. The wizard would have previously registered itself with the AfwRegister function, e.g., FIG. 4 item 402. Once the wizard is active, if needed, it may provide instructions and/or configuration questions to a user to assist with installing the new device. While in some cases no intervention by the user is required, thus making matters very simple for a user, in other cases, such as when introducing a wireless access point, it may be desirable to prompt a user for a SSID (service set identifier) or other personalization data to associate with the new device.

As noted above, it is presumed that an in-band communication channel can be (or already is) compromised. A typical example of a high-risk in-band channel is a public wireless “hotspot,” e.g., a place providing public network access, or a hotel room network connection. To avoid the new device being compromised when it is introduced, in various embodiments, an initial OOB data transfer with the new device is, performed to bootstrap establishing a secure communication channel over which to then configure the new device. For example, assuming the OOB data contains a cryptosystem key(s), as discussed above for FIGS. 1-2, the new device and Registrar, or other existing device, proxy, etc., use the cryptosystem key(s) to establish a secure communication channel with the new device. It will be appreciated various cryptographic protocols and techniques may be used; in some embodiments, the new device may request the Registrar (or more specifically its Framework Protocol Stack) to act as a certificate authority (CA) for use of X.509 type certificates.

Continuing with FIG. 3, in one embodiment, below line components 306-312, such as a Registrar or other device, may have associated policies that control features of the new device that may be allowed to become active. For example, while a new device may support instant messaging, the Registrar may be configured to ignore and/or not configure such features of software for a new device. Similarly, while a particular environment may support certain activity, such as allowing access to streaming media, a particular device may nonetheless have its own local policy or policies set such that the device does not or can not utilize the activity even though present and available in the environment.

In one embodiment, a user interface (not illustrated) is provided an identifier for each application that registers (or perhaps has already registered) with the Application Framework 302, and the User Interface provides a control to allow opportunity for a user to permit or deny an application's registration. In the illustrated embodiment, Legacy Applications 1 320 to N 322 may also be integrated within the environment to use the Application Framework 302. To do so, in the illustrated embodiment, an Application Proxy 324 is provided that automatically interfaces between interfaces for a legacy application and the Application Framework. It will be appreciated there are many techniques to perform the integration, such by providing virtual execution environments, control wrappers, execution scripts, or the like.

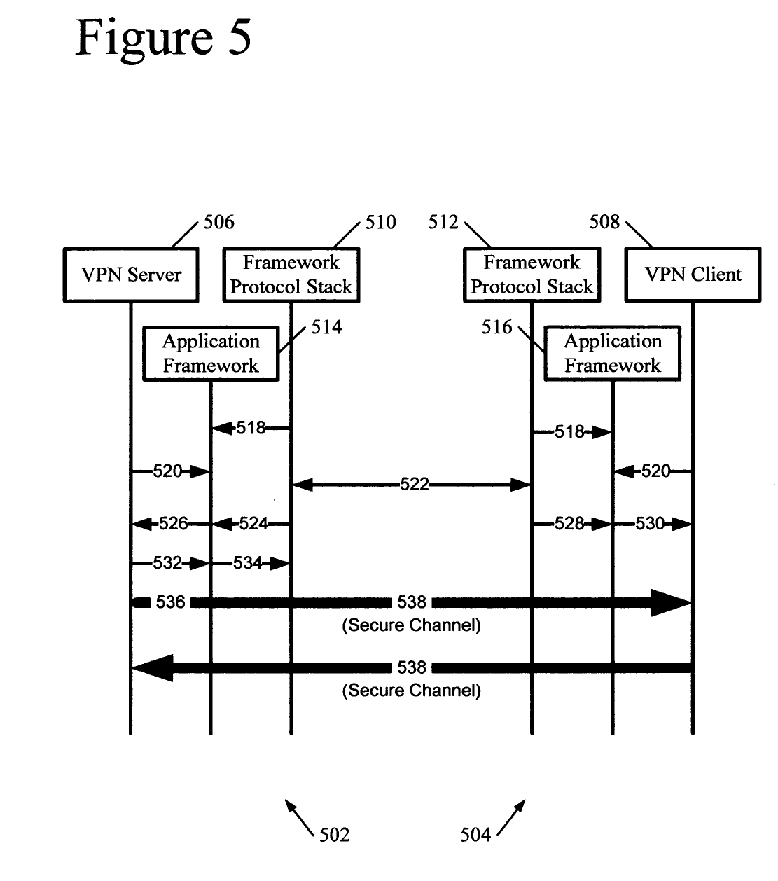

FIG. 5 illustrates an exemplary data-flow diagram 500 for configuring a Shared Key based VPN (Virtual Private Network) according to one embodiment. It should be appreciated that the VPN is presented for expository purposes only since it represents a complex environment to configure; the principles of this and the FIG. 5 are applicable to automatically configuring any newly introduced device.

Configuring a VPN Client 508 is a challenging and tedious prospect for both the average user, as well as for many experienced users. Depending on the type of VPN operating mode, e.g., IPsec (Internet Protocol security) based, SSL (Secure Sockets Layer) based, proprietary encryption based, etc., in order to allow a VPN Server 506 and VPN Client establish cryptographically secure communication, a user must transfer or install secrets, e.g., cryptographic key(s), X.509 certificate(s), etc., to both the new device and the VPN server. Typically, a user would also have to establish VPN configuration files by modifying default configuration files and/or answering questions in a graphical user interface (GUI). It will be appreciated the VPN operating mode may support Mobile IP to allow endpoint mobility across different access networks.

Using the Application Framework, e.g. FIG. 3 item 302, VPN configuration can be greatly simplified. In the illustrated embodiment, it is assumed the left side 502 of the illustration corresponds to actions taken by a Registrar, while the right side 504 of the illustration corresponds to actions of a new device being introduced into an environment, such as a local area network, wide area network, etc. Note that while the present description discusses various interactions with a Registrar, it will be appreciated that any existing device in a network may perform the operations attributed herein to a Registrar.

A first operation 518 is to initialize (as needed) the Application Frameworks 514, 516. Note that in the illustrated embodiment, the same reference numerals are used when both the Registrar and new device are performing substantially the same operation. It is assumed the Registrar and new device both maintain an Application Framework 514, 516, however, it will be appreciated in other embodiments, there may be one or many Application Frameworks with which devices may communicate and register.

Once initialized, both the VPN Server and VPN Client application(s) (or a VPN Proxy, in case of a legacy application) register 520 with the Application Framework 514 with a request to receive introduction notification for the new device. As illustrated, both the Registrar and new device may have separate Framework Protocol Stacks 510, 512 and Application Frameworks 514, 516; however, while the VPN client 508 may take on the role of Registrar for another device (not illustrated) and receive requests for new device introduction notifications, in the illustrated embodiments, the VPN applications register 520 for introduction notifications with the Registry's Application Framework 514.

When a new device is introduced into an environment, such as a wired and/or wireless network, an introduction ceremony is performed 522 to introduce the new device. As discussed previously, introduction requires first performing an out-of-band (OOB) data transfer to bootstrap establishing a secure communication channel over which to configure the new device. In one embodiment, the user may execute a graphical user interface (GUI) that assists with the OOB data transfer, e.g., the GUI may provide instructions on what to do with different OOB technology. The GUI may also query the Application Framework 514 and list applications that have registered to be notified of the introduction of the new device. In one embodiment using the GUI, the user may modify an application's configuration.

Assuming device introduction succeeds, the VPN applications 506, 508 are notified of the introduction. At this point, the VPN applications can begin to negotiate a secure communication channel based on the OOB data transfer. As illustrated, the Registrar Framework Protocol Stack 508 notifies 524 the Application Framework of the successful introduction, and the Application Framework in turn notifies 526 the VPN Server 506; similarly, the new device Framework Protocol Stack 512 notifies 528 the Application Framework 516 of the successful introduction, and the Application Framework in turn notifies 530 the VPN Client 508 of the successful introduction. Responsive to the notification 526, the VPN Server sends 532 a request to the Application Framework 514 to generate a key of a desired (arbitrary) length sufficient to meet security concerns. The Application Framework in turn requests 534 the key from the Framework Protocol Stack, which generates the requested key and returns (not illustrated) it to the VPN Server.

In the illustrated embodiment, this will operate as a shared key between the VPN applications 506, 508. The VPN Server then generates the required VPN configuration file for the VPN Client. The configuration file contains settings controlling how the VPN applications interact depending on the specific VPN technology in use. Typically, a configuration file indicates details such as what communication protocol to use (e.g., Transmission Control Protocol/Internet Protocol (TCP/IP), User Datagram Protocol (UDP), etc.), the VPN Server's host name or Internet Protocol (IP) address, Secure Sockets Layer (SSL) or Transport Layer Security (TLS) parameters and/or credentials, etc. It will be appreciated that many different options may be set and that both the VPN Server and VPN Client need to have compatible configurations in order for communication to succeed.

The VPN Server forwards 536 the shared key (or equivalent, e.g., a digital certificate or the like) and the configuration file to the Application Framework 514 for providing to the VPN Client 508. The Application Framework 514 uses the Framework Protocol Stack 510 to send the shared key and configuration file to the VPN Client's Application Framework 516 over a secure channel 538 determined based on OOB data. In one embodiment, OOB data may be used to authenticate an in-band channel. The in-band channel may be used, as discussed below, to derive authenticated keys that may be used to protect exchange of configuration data over the in-band channel. As will be appreciated, the shared key (or equivalent) may also come from a Domain Manager, e.g., FIG. 3 item 310, which may or may not be the physical entity as the VPN Server. The Application Framework 516 for the VPN Client 508 receives the shared key and configuration file and forwards it to the VPN Client.

The VPN Client 508 installs the configuration file and stores the shared key so that it may engage in secure communication with the VPN Server 506. In the illustrated embodiment, the VPN Client sends a response to the VPN Server over a secure channel 540 (e.g., a secure in-band channel) to indicate it received the information correctly. It will be appreciated that the secure channels 538, 540 are arbitrarily labeled as separate channels and may in fact be the same channel. In such fashion, when a new device is introduced to an environment having an associated VPN Client, this client can be automatically configured to work with the VPN Server without user intervention. Note that the VPN applications 506, 508 may be respectively be applications executing on the Registrar and new device, or they may instead simply be software associated with these devices but executing on other devices and simply interact when needed as described above.

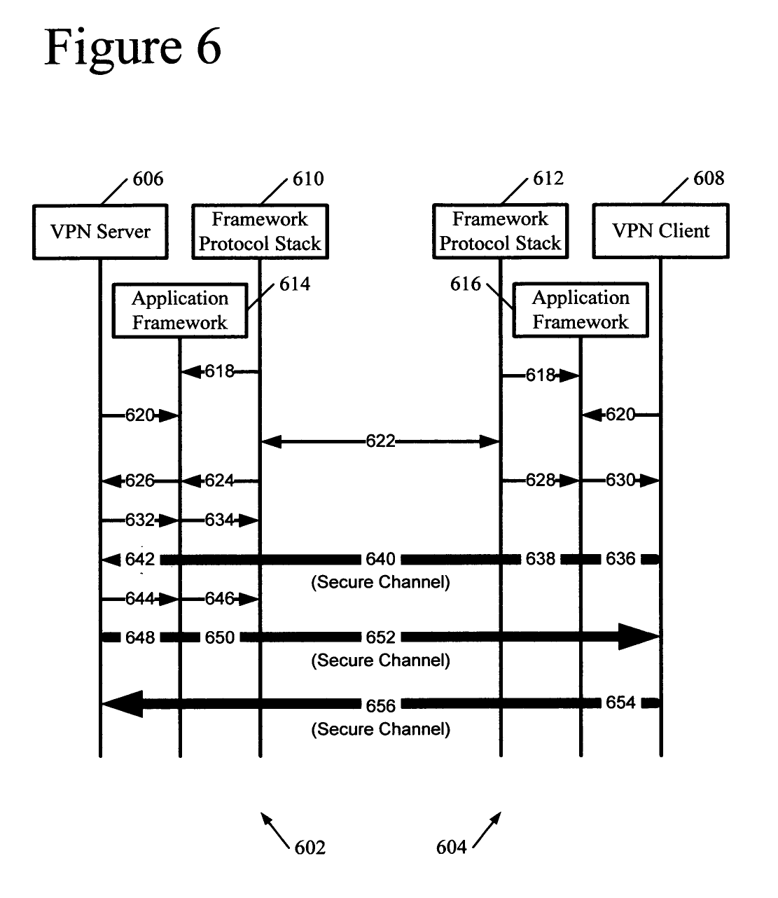

FIG. 6 illustrates another exemplary data-flow diagram 600 for configuring a certificate-based VPN according to one embodiment. It should be appreciated this VPN is also presented for expository purposes since it represents another complex environment to configure. Also, due to the overlap in this figure with concepts of FIG. 5, some language pertaining to alternate embodiments and approaches is left unstated. As in FIG. 5, in order to allow a VPN Server 606 and VPN Client establish cryptographically secure communication, a user must transfer or install secrets to both the new device and the VPN server and establish VPN configuration files. As in FIG. 5, the left side 602 of the illustration corresponds to actions taken by a Registrar, while the right side 604 corresponds to actions of a new device being introduced into an environment.

A first operation 618 is to initialize (as needed) the Application Frameworks 614, 616. Note that the same reference numerals are used if different devices are performing similar operations. Once initialized, both the VPN Server 606 and VPN Client application(s) 608 (or a VPN Proxy, in case of a proxy being used to support a legacy application) register 620 with the Registrar's Application Framework 614 with a request to receive introduction notification for the new device.

When the new device is introduced into an environment, such as a wired and/or wireless network, an introduction ceremony is performed 622 to introduce the new device. As discussed previously, introduction requires first performing an out-of-band (OOB) data transfer to bootstrap establishing a secure communication channel over which to configure the new device.

Assuming device introduction succeeds, the VPN applications 606, 608 are notified of the introduction. At this point, the VPN applications can begin to negotiate a secure communication channel based on the OOB data transfer. As illustrated, the Registrar Framework Protocol Stack 608 notifies 624 the Application Framework of the successful introduction, and the Application Framework in turn notifies 626 the VPN Server 606; similarly, the new device Framework Protocol Stack 612 notifies 628 the Application Framework 616 of the successful introduction, and the Application Framework in turn notifies 630 the VPN Client 608 of the successful introduction.

Responsive to the notification 626, assuming public key encryption, the VPN Server 606 generates a Public/Private key pair and a Certificate Signing Request (CSR). Generally, a CSR is sent to a Certificate Authority (CA) to be signed, and once signed, a certificate, e.g., an X.509 type of certificate, is returned by the CA. In the illustrated embodiment, the Framework Protocol Stack operates as a CA. It will be appreciated that except where required otherwise herein, any cryptographic technique may be employed in connection with the illustrated embodiments, hence a CA and an X.509 certificate are presented for exemplary purposes only as these techniques are well known in the art. The VPN Server sends 632 the CSR to the Application Framework 614, which in turn sends 634 the CSR request to the Framework Protocol Stack 610. Since the Framework Protocol Stack is operating as a CA, it signs the CSA and returns (not illustrated) the certificate to the VPN Server 606.

Responsive to the notification 626, the VPN Client 608 also generates a Public/Private key pair and a Certificate Signing Request (CSR) and sends 636 the CSR and keys to the Application Framework 616, which in turn provides 638 them to the Framework Protocol Stack 612 for secure transmission to a peer device's (e.g., the Registry) Application Framework 614 over a secure channel 640 determined at least in part based on the initial OOB data transfer. The Application Framework 614 forwards 642 the CSR and keys to the VPN Server 606 for processing. The VPN Server sends 644 the VPN Client CSR to the Application Framework 614 which in turn sends 646 the request to the Framework Protocol Stack 610 for signing. Acting as a CA, the Framework Protocol Stack signs the VPN Client's certificate with the same CA key used for signing the VPN Servers certificate.

The VPN Server 606 then sends 648 the signed VPN Client 608 certificate, the CA certificate used to sign the VPN Client certificate and a VPN configuration to configure the VPN Client to the Application Framework 614, which in turn sends 650 it to the Framework Protocol Stack 610 to deliver over a secure channel 652 to the VPN Client's 608 Framework Protocol Stack 612 for delivery to the VPN Client for processing. In one embodiment, the VPN Server certificate may also be sent to the VPN Client.

The VPN Client 608 stores the received client certificate and applies the provided configuration. Once configured, the VPN Client sends 654 a response message to the VPN Server 606 over a secure channel 656 to indicate it received the information correctly. It will be.appreciated that the secure channels 640, 652, 656 are arbitrarily labeled as separate channels when in fact they may be the same channel.

It will be appreciated by one skilled in the art that the FIG. 3 Application Proxy 324 may be substituted in the above FIGS. 5, 6 discussion for VPN Applications 506, 508, 606, 608, and operate in accord with the illustrated principles to extend the illustrated embodiments to supporting legacy applications 320, 322 unable to utilize the Application Framework 302.

Continuing with the FIGS. 2 discussion, the following illustrates, according to one embodiment, how other application-specific keys can be derived from device introduction, e.g., FIG. 5 introduction ceremony 522. Table 1 shows an exemplary detailed structure of the eight (8) messages exchanged in FIGS. 2 between client (“C”) and Registrar (“R”) according to an embodiment of the invention.

| Message | Direction | Structure |
|---|---|---|
| M1 | C→R | Version \|\| N1 \|\| Description \|\| PK_{E} |
| M2 | R→C | Version \|\| N1 \|\| N2 \|\| Description \|\| PK_{R} |
| M3 | C→R | Version \|\| N2 \|\| E-Hash1 \|\| E-Hash2 \|\| |
| | | HMAC_{AuthKey}(M1\|\|M2*) |
| M4 | R→C | Version \|\| N1 \|\| R-Hash1 \|\| R-Hash2 \|\| |
| | | ENC_{KeyWrapKey}(R-S1) \|\| HMAC_{AuthKey}(M3\|\|M4*) |
| M5 | C→R | Version \|\| N2 \|\| ENC_{KeyWrapKey}(E-S1) \|\| |
| | | HMAC_{AuthKey}(M4\|\|M5*) |
| M6 | R→C | Version \|\| N1 \|\| ENC_{KeyWrapKey}(R-S2) \|\| |
| | | HMAC_{AuthKey}(M5\|\|M6*) |
| M7 | C→R | Version \|\| N2 \|\| ENC_{KeyWrapKey}(E-S2) \|\| |
| | | HMAC_{AuthKey}(M5\|\|M6*) |
| M8 | R→C | Version \|\| N1 \|\| ENC_{KeyWrapKey}(Credential) \|\| |
| | | HMAC_{AuthKey}(M7\|\|M8*) |

| Symbol | Meaning |
|---|---|
| \|\| | Concatenation of parameters |
| Mₙ* | Message Mₙ (excluding a hash value suffix) |
| Version | Protocol version number |
| N1, N2 | 128-bit random numbers |
| Description | Text string describing a device that transmitted the |
| | corresponding message |
| PK_{E} | Diffie-Hellman public key of client |
| PK_{R} | Diffie-Hellman public key of Registrar |
| E-S1, E-S2 | Two secret random numbers selected by client |
| E-Hash1, E-Hash2 | Keyed cryptographic hashes of E-S1 and E-S2, |
| | respectively (each hashed together with separate |
| | halves of the client's device password) |
| R-S1, R-S2 | Two secret random numbers selected by Registrar |
| R-Hash1, R-Hash2 | Keyed cryptographic hashes of R-S1 and R-S2, |
| | respectively (each hashed together with separate |
| | halves of the client's device password) |
| Enc_{Key}(item) | Item encrypted with Key |
| HMAC_{Key}(item) | HMAC keyed hash of item using key Key |

In the embodiment defined by messages M1-M8, the participants in the registration protocol identify themselves in their first messages (M1 and M2). Messages M3-M8 contain a message authentication code (“MAC”) to permit the recipient to verify that the protocol messages have not been corrupted or tampered with. In this embodiment, the MAC of a message is a cryptographic hash calculated over the data of the previous message and data of the current message, excluding the MAC portion of the current message. HMAC_{Key} is a keyed hash, which can only be generated or validated by a party that possesses the key. Selection of keys is discussed below.

In an embodiment that uses the eight messages shown in Table 1, note that the client and Registrar may each divide the device password into two portions and incrementally and in alternating fashion prove knowledge of those two portions in several successive messages (M3-M7), e.g. messages M3-M7 may incrementally demonstrate mutual knowledge of a password. Once parties have proven knowledge of the password, encrypted configuration data can be exchanged. This improves the security of the protocol by thwarting a potential attack to obtain the device password. Several portions of messages M1-M8 may be encrypted to prevent an eavesdropper from learning privileged information such as the device password or the credential.

Some of the message parameters—for example, E-S1, E-S2, R-S1 and R-S2—may be random bit strings selected by either the client or the Registrar. Other message parameters must be known to both entities so that one side can encrypt and/or authenticate a message and the other side can decrypt and/or authenticate it. Some embodiments of the invention will use a key derivation key (“KDK”) that is computed from the Diffie-Hellman secrets, random numbers N1 and N2, or nonces (unique numbers which may be embedded in messages to protect against attack), and a Media Access Control (“MAC”) address of the client. It will be appreciated that various public key technologies such as DSA, RSA, elliptic curve, etc. may be used to determine the KDK. In these cases, M3 includes a proof-of-possession of the client's public key, and the Registrar encrypts the KDK using the client's public key and sends it to the client in M4.

In one embodiment, the KDK can be determined by computing HMAC-SHA-256_{DHKey}(N1∥EnrolleeMAC∥N2). The DHKey may be defined as SHA-256(g^{AB}mod p), the PK^{E} as g^{A}mod p, and the PK_{R} as g^{B}mod p, where the new device and Registrar know the secret values A and B, respectively. It will be appreciated additional keys may be derived from the KDK using a key derivation function. For example, an Application-specific master session key (AMSK) or simply “master session key” can be derived from the KDK to bootstrap trust for other applications. The AMSK may then be used, for example, to secure additional application-specific configuration functions for the new device.

In some embodiments, a portion of the protocol implemented through messages M1-M8 can be short-circuited. If a secure communication channel between client and Registrar exists, the Registrar can use that channel to transmit a credential for the client. For example, if the Registrar and client can both use an Out-Of-Band (OOB) communication channel, e.g., a removable storage medium such as a Universal Serial Bus (“USB”) Solid State Disk, NFC, or other communication channel, then the Registrar may write the credential in a file on the USB disk and the client may obtain the credential by reading the file. Information transmitted via the secure channel may still be encrypted to protect against unauthorized access and/or tampering, or to permit the client to verify that the credential came from an authorized Registrar.

The protocol described above can be used in several additional situations. First, consider the problem of associating a new Registrar with an existing access point (“AP”). The protocol can operate between the new Registrar and the AP, with the AP taking the role of the client. This use of the protocol might be indicated by a different EAP Identity string. For example, the string “SomePrefix-Registrar-1-0” could indicate to the AP that a Registrar wished to associate itself with the AP. Some protocol messages may be modified to carry information of use in this scenario. For example, the AP may include information about its present configuration when it transmits M7. The configuration information may be encrypted. The Registrar, upon receiving the AP's present configuration, may prepare an updated or new configuration and transmit it to the AP as part of the credential in message M8. The new configuration would also be encrypted in that message. The protocol could be used again, after a client device had successfully received a credential, if new credentials were to be distributed. This use of the protocol is known as “rekeying.” A client participating in a rekeying operation might use a different value for the device password. In one embodiment, the device password could be a 256-bit pseudo-random bit.

Thus the foregoing descriptions and explanations detailed a secure protocol by which two entities can authenticate each other, transfer a credential over an insecure environment, such as an 802.11 wireless network, other radio network, public access network, or the like, and provide for automatically configuring a new device added to the environment. Assuming, for example, a new device is a mobile WLAN device, and an access point (“AP”) has associated therewith a Registry, the FIGS. 1-6 embodiments may be used even when the client does not yet have a credential that the AP will accept. In this WLAN case, the client may structure its messages (and receive its replies) according to the IEEE 802.1x protocol. The AP may accept 802.1x-formatted formatted messages and forward them to the Registrar (or process them internally, if the AP itself contains the Registrar), even though the client transmitting the messages lacks an acceptable WEP key or other credential or security arrangement for secure communication.

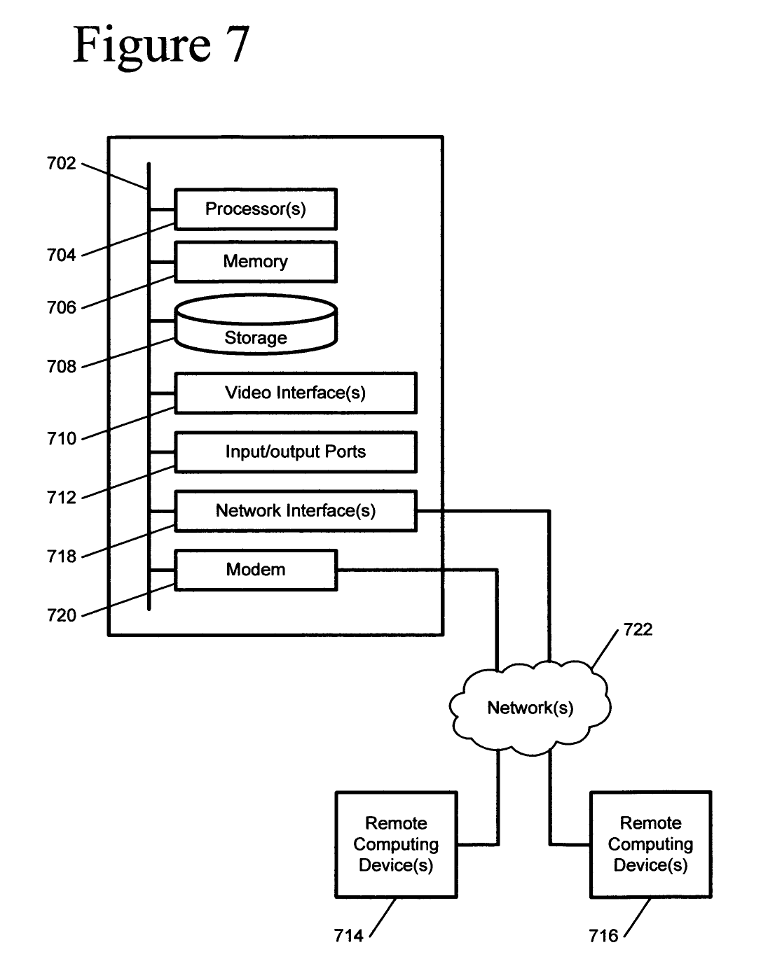

FIG. 7 and the following discussion are intended to provide a brief, general description of a suitable environment in which certain aspects of the illustrated invention may be implemented. As used herein below, the term “machine” is intended to broadly encompass a single machine, or a system of communicatively coupled machines or devices operating together. Exemplary machines include computing devices such as personal computers, workstations, servers, portable computers, handheld devices, e.g., Personal Digital Assistant (PDA), telephone, tablets, etc., as well as transportation devices, e.g., automobiles, trains, cabs, etc.

Typically, the environment includes a machine 700 that includes a system bus 702 to which is attached processors 704, a memory 706, e.g., random access memory (RAM), read-only memory (ROM), or other state preserving medium, storage devices 708, a video interface 710, and input/output interface ports 712. The machine may be controlled, at least in part, by input from conventional input devices, such as keyboards, mice, etc., as well as by directives received from another machine, interaction with a virtual reality (VR) environment, biometric feedback, or other input source or signal.

The machine may include embedded controllers, such as programmable or non-programmable logic devices or arrays, Application Specific Integrated Circuits, embedded computers, smart cards, and the like. The machine may utilize one or more connections to one or more remote machines 714, 716, such as through a network interface 718, modem 720, or other communicative coupling. Machines may be interconnected by way of a physical and/or logical network 722, such as an intranet, the Internet, local area networks, and wide area networks. One skilled in the art will appreciated that communication with network 722 may utilize various wired and/or wireless short range or long range carriers and protocols, including radio frequency (RF), satellite, microwave, IEEE 802.11, Bluetooth, optical, infrared, cable, laser, etc.

The invention may be described by reference to or in conjunction with associated data such as functions, procedures, data structures, application programs, etc. which when accessed by a machine results in the machine performing tasks or defining abstract data types or low-level hardware contexts. Associated data may be stored in, for example, volatile and/or non-volatile memory 706, or in storage devices 708 and/or associated storage medium, including conventional hard-drives, floppy-disks, optical storage, tapes, flash memory, memory sticks, digital video disks, etc., as well as more exotic mediums such as machine-accessible biological-based state preserving storage. A “machine readable” medium includes any mechanism for storing or transmitting associated data in a form readable by a machine. Associated data may be delivered over transmission environments, including the wireless network discussed in FIG. 1, in the form of packets, serial data, parallel data, propagated signals, etc., and may be used in a compressed or encrypted format. Associated data may be used in a distributed environment, and stored locally and/or remotely for access by single or multi-processor machines. Associated data may be used by or in conjunction with embedded controllers; hence in the claims that follow, the term “logic” is intended to refer generally to possible combinations of associated data and/or embedded controllers.

Thus, for example, with respect to the illustrated embodiments, assuming machine 700 embodies the VPN Server 506 of FIG. 5, then remote machines 714, 716 may respectively be client machines such as FIG. 5 VPN Client 508. It will be appreciated that remote machines 714, 716 may be configured like machine 700, and therefore include many or all of the elements discussed for machine. It will be further appreciated messages according to an embodiment of the invention may be transmitted as data encapsulated in a higher level protocol such as the User Datagram Protocol (“UDP”) or Transmission Control Protocol (“TCP”), running over the Internet Protocol (“IP”). Alternatively, messages could be formatted in the Extensible Markup Language (“XML”) and embedded in Hypertext Transfer Protocol (“HTTP”) transactions according to the Universal Plug-n-Play (“UPnP™”) standard promulgated by the UPnP Forum.

Having described and illustrated the principles of the invention with reference to illustrated embodiments, it will be recognized that the illustrated embodiments can be modified in arrangement and detail without departing from such principles. And, though the foregoing discussion has focused on particular embodiments, other configurations are contemplated. In particular, even though expressions such as “in one embodiment,” “in another embodiment,” or the like are used herein, these phrases are meant to generally reference embodiment possibilities, and are not intended to limit the invention to particular embodiment configurations. As used herein, these terms may reference the same or different embodiments that are combinable into other embodiments.

Consequently, in view of the wide variety of permutations to the embodiments described herein, this detailed description is intended to be illustrative only, and should not be taken as limiting the scope of the invention. What is claimed as the invention, therefore, is all such modifications as may come within the scope and spirit of the following claims and equivalents thereto.

What is claimed is:

1. A method including using out-of-band (OOB) data transferred from a new device to an environment to an existing device of the environment, said OOB data including data for establishing at least a first secure communication channel between the existing device and the new device:
establishing the first secure communication channel based at least in part on said OOB data;
providing the new device at least one secret over the first secure communication channel;
establishing a second secure communication channel between the existing device and the new device based at least in part on knowledge of said secret;
providing configuration data to the new device over the second secure communication channel; and
automatically configuring the new device based at least in part on said configuration data.

2. The method of claim 1, wherein the at least one secret is mutually derived with the new device.

3. The method of claim 1, further comprising:
provisioning a cryptographic certificate on the new device based at least in part on said secret.

4. The method of claim 3, wherein the cryptographic certificate comprises an X.509 type certificate.

5. The method of claim 1, further comprising automatically:
determining a configurable capability of the new device;
identifying a configuration type for the configurable capability; and
determining if said configuration data includes configuration data corresponding to the configurable capability, and if so, configuring the new device accordingly.

6. The method of claim 5, further comprising:
if not, querying for configuration data for the configurable capability; and
storing said queried configuration data to provide for said automatically configuring devices having the configurable capability.

7. The method of claim 1, wherein said OOB data transfer comprises transferring a secret from the existing device to the new device.

8. The method of claim 7, wherein said transferring the secret comprises temporarily communicatively coupling a component of the new device with the existing device, and while coupled thereto, transferring the secret through said temporary communicative coupling.

9. The method of claim 8, wherein said temporary communicative coupling comprises a selected one of:
the new device reading a short range emission of the existing device;
establishing a short range wireless connection between the existing device and the new device; or
first attaching to the existing device a portable memory operable to store the secret, and second attaching to the new device the portable memory containing the secret.

10. The method of claim 1, further comprising:
initializing an application framework to receive component introduction notifications; and
receiving a component introduction notification responsive to presenting the new device to the network.

11. The method of claim 1, further comprising determining a master session key based at least in part on the at least one secret to allow deriving therefrom additional secure communication channels.

12. The method of claim 11, further comprising deriving a second secret from the master session key for establishing secure communication for an application program associated with the new device.

13. The method of claim 11, further comprising:
introducing an other new device into the environment;
deriving a second secret from the master session key; and
establishing a third secure communication channel between the existing device and the other new device based at least in part on the second secret.

14. An article comprising a machine-accessible medium having one or more associated instructions for using out-of-band (OOB) data transferred from a new device to an environment to an existing device of the environment, said OOB data including data for establishing at least a first secure communication channel between the existing device and the new device, wherein the one or more instructions, if executed, results in a machine performing:
establishing the first secure communication channel based at least in part on said OOB data;
providing the new device at least one secret over the first secure communication channel;
establishing a second secure communication channel between the existing device and the new device based at least in part on knowledge of said secret;
providing configuration data from the existing device to the new device over the second secure communication channel; and
automatically configuring the new device based at least in part on said configuration data.

15. The article of claim 14 wherein the machine-accessible media further includes instructions, when executed, results in the machine performing:
mutually deriving the at least one secret key with the new device.

16. The article of claim 14 wherein the machine-accessible media further includes instructions, when executed, results in the machine performing:
provisioning a cryptographic certificate on the new device based at least in part on said secret.

17. The method of claim 16, wherein the certificate comprises an X.509 type certificate.

18. The article of claim 14 wherein the machine-accessible media further includes instructions, when executed, results in the machine automatically performing:
determining a configurable capability of the new device;
identifying a configuration type for the configurable capability; and
determining if said configuration data includes configuration data corresponding to the configurable capability, and if so, configuring the new device accordingly.

19. The article of claim 18 wherein the machine-accessible media further includes instructions, when executed, results in the machine performing:
if not, querying for configuration data for the configurable capability; and
storing said queried configuration data to provide for said automatically configuring devices having the configurable capability.

20. The article of claim 14, wherein:
said OOB data transfer comprises transferring or mutually deriving a secret from the existing device to the new device by temporarily communicatively coupling a component of the new device with the existing device, and while coupled thereto, transferring or mutually deriving the secret through said temporary communicative coupling; and
said temporary communicative coupling comprises a selected one of: the new device reading a short range emission of the existing device; establishing a short range wireless connection between the existing device and the new device; or first attaching to the existing device a portable memory operable to store the secret, and second attaching to the new device the portable memory containing the secret.

21. The article of claim 14 wherein the machine-accessible media further includes instructions, when executed, results in the machine performing:
initializing an application framework to receive component introduction notifications; and
receiving a component introduction notification responsive to presenting the new device to the network.

22. The article of claim 14 wherein the machine-accessible media further includes instructions, when executed, results in the machine performing:
determining a master session key based at least in part on the secret to allow deriving therefrom additional secure communication channels; and
deriving a second secret from the master session key for establishing a third secure communication channel for an application program communicatively coupled with the environment.

23. A system comprising:
a first device having a device password;
an access point to provide network access to devices having a credential; and
a registrar;
wherein the registrar is to receive the device password by an out-of-band (OOB) data transfer, and is to provide a credential to the first device for use by the first device to access the network through the access point.

24. The system of claim 23, wherein:
the first device includes a near-field communication (“NFC”) token to contain the device password;
the Registrar includes a near-field communication reader to read an NFC token; and
the registrar is to obtain the first device's device password by reading the first device's NFC token.

25. The system of claim 23 wherein the first device further comprises a radio communication interface to receive the credential.

26. The system of claim 23 wherein the first device further comprises a removable storage interface to receive the credential.
